(19) United States
(12) Patent Application Publication
(10) Pub. No.: US 2005/0267798 A1
(43) Pub. Date: Dec. 1, 2005

(54) Auxiliary content delivery system

(76) Inventor: Tiziano Panara, Auckland (NZ)

Correspondence Address: GREENBERG TRAURIG, LLP, 77 WEST WACKER DRIVE, SUITE 2500, CHICAGO, IL, 60601-1732, US

(21) Appl. No.: 10/523,237

(22) PCT Filed: Jul. 22, 2003
(86) PCT No.: PCT/CA03/01046

§ 371 Date: Jan. 20, 2005

Related U.S. Application Data
(60) Provisional application No. 60/397,044, filed on Jul. 22, 2002.

(51) Int. Cl. G06F 17/60

(52) U.S. Cl. 705/14

(57) ABSTRACT

A computer-based method for delivering auxiliary content, involves the steps of (1) receiving over a network a request from a client terminal for the auxiliary content, wherein each item of the auxiliary content has an associated broadcast comprising a respective time slot; and (2) selecting one of the items in accordance with a correlation between the broadcast spaces and a time instant of a request from the client terminal for the auxiliary content.

### RELATED APPLICATIONS

This application claims the benefit of U.S. provisional patent application No. 60/397,644, filed Jul. 22, 2002.

### FIELD OF THE INVENTION

The present invention relates to a computer-based content delivery system. In particular, the present invention relates to a client-server model for delivering auxiliary content to network users based on their respective information interests.

### BACKGROUND OF THE INVENTION

The World Wide Web developed as a mechanism for providing computer users with improved access to networked information resources. Today, the World Wide Web offers both consumer and commercial benefits. Encouraged by the development of browser software, end consumers spend several hours per week accessing and downloading informational and entertainment content available over the World Wide Web. Spirited by the exponential growth in such end consumer activity, businesses have turned to the World Wide Web to promote their products and services. Whereas, the conventional approach to such promotion has been through the promulgation of web pages each describing and/or offering for sale one or more vendors' products or services, more recently businesses have turned to a more active approach to product and service promotion.

The most common such approach has consisted of a banner advertisement embedded in a web page having a high traffic volume. Typically, the banner advertisement is displayed in a portion of the web page, and entices the consumer to select the banner advertisement, thereby redirecting the end user to a web page describing the vendors' products or services. The business may pay the host of the referring web page a fee based either on the number of instances the hosting web page redirected the end user to the vendors web page, or on the traffic volume of the referring web page. Unfortunately, given the limited bandwidth available to many computer users, banner advertisements are typically very limited in size and complexity so as to not unduly increase the time required to generate the referring web page. Further, many consumers find banner advertisements to be a nuisance, in that the advertisements typically have little or no relevance to the consumer's interests. Consequently, attempts have been made to provide an improved mechanism for delivering auxiliary content to end users over a wide area network, such as the World Wide Web.

For instance, Murphy (U.S. Pat. No. 5,305,195) describes an interactive system for providing advertising information to remote terminals, comprising a number of local terminals, a mainframe and a local server in communication with the local terminals, and a remote commercial computer in communication with the local server. Periodically, the remote commercial computer transmits an advertisement, in the form of a compressed digital video signal, to the local server, which in turn redirects the video signal to the associated local terminals for storage on their respective hard discs.

Each local terminal transmits information requests to the mainframe computer and, in the interim period before the mainframe computer responds to the request, the local terminal displays the advertisement to the user of the local terminal. Since the local terminal renders the advertisement from the compressed video signal stored on the terminal's local hard disc, the terminal user is provided with a rich visual experience. However, since each local terminal is provided with the same advertising video, the advertisement is not targeted to the interests of the terminal user.

Judson (U.S. Pat. No. 5,737,619) describes a method of delivering additional content over the World Wide Web to client machines, while each client machine waits for a requests hypertext document to be downloaded from a target web page. Preferably, the additional content comprises an information object that is embedded in a HTML comment tag of the target web page, so that the information object is invisible to the user of the client machine when the target web page is rendered. The target web includes hypertext link to a document located at a remote server, which link is associated with the embedded information object. When the target web page is displayed at the client machine, the information object is stored in memory of the client machine.

Subsequently, when the hypertext link is selected, the client machine begins downloading the document from the remote server, and at the same time retrieves the information object from memory, rendering same on the display device of the client machine. With this approach, the additional content is displayed to the user while the client machine is waiting for the requested document to be downloaded from the remote server. However, as the information object is embedded in the target web page, the information object is not targeted to the interests of the client machine.

Rakavy (U.S. Pat. No. 5,913,040) describes a system for delivering advertisements over the Internet to a user's computer, comprising an advertising server, and a number of local computers in communication with the advertising server. The advertising server has an advertising database that identifies a number of available advertisements. Each local computer includes a local user preference and advertisement database, that identifies the resources available locally for rendering the advertisements, and configuration and user preference information. The configuration information identifies the platform capabilities of the local computer. The preference information typically identifies the categories of preferred advertisements, and the time periods during which the local computer will receive advertisements from the advertising server.

When a local computer connects to the advertising server, the local computer uploads the configuration and user preference information to the advertising server. The advertising server compares the uploaded information against category information for the available advertisements to thereby identify the next advertisement for download to the local computer. The advertising server then provides the local computer with a resource list identifying the components (eg. executable code, bitmaps, sound clips) required to render the identified advertisement.

Upon receipt of the resource list, the local computer queries the local user preference and advertisement database to identify those components that the local computer lacks, and then uses a “polite agent” to request the advertising server download same to the local computer when the utilization of the communications link to the local computer is below a predetermined threshold. The local computer stores the received components locally, rendering the advertisements to the user after the local computer has been idle for a predetermined period of time. With this approach, the advertisement is only downloaded during instances of low utilization of the communication bandwidth. However, as the subject matter of the advertisement is selected based on the categories of interest specified by the user, this effectiveness of this solution is limited by the accuracy of the preference information contained in the local user preference and advertisement database. Further, this solution suffers from limited scalability, since each business interested in the solution must have an associated advertising server.

Landsman (WO 99/60504) describes a system for downloading advertising content over the Internet to client computers, comprising at least one web server, an HTTP server (“distribution server”), a third party advertising server hosting an ad management system, and a number of local computers in communication with the web servers and the distribution server. Each client computer is configured with an Internet browser that preferably supports dynamic writing of applet tags, and includes a Java Virtual Machine. The ad management system includes media and player files required to render an advertisement.

Each web server includes a web page having an embedded HTML “advertising tag”. One portion of the advertising tag references a JavaScript file stored on the distribution server. The JavaScript file, when downloaded by the client browser executed by the Java Virtual Machine, dynamically writes applet tags into the referring web page in lieu of the advertising tag. Collectively these applet tags form a Transition Sensor applet which, when executed by the client browser, loads and instantiates an AdController applet in the client browser.

Another portion of the advertising tag includes the URL of the ad management system from which the AdController applet is to download an advertisement. The Transition Sensor applet passes this URL to the AdController applet which, in turn, requests delivery of an advertisement from the ad management system.

The ad management system selects an advertisement for delivery, and responds with an AdDescriptor file containing a list of the file names and addresses of all media and player files necessary to render the associated advertisement. The advertisement can be selected randomly. Alternately, the advertisement can be selected based on user preference or user-specific information that was previously collected from the user and uploaded to the ad management system.

Upon receipt of the AdDescriptor file, the AdController applet downloads the specified media and player files from the ad management system, to the extent that these files do not already reside on the client computer. The request for delivery of the advertisement (and the delivery of the advertisement) is routed through the distribution server acting as a proxy server.

The Transition Sensor applet also monitors the click stream generated by the user. When the Transition Sensor applet detects a user-initiated page transition (and, therefore, the start of an interstitial interval), the AdController applet renders the advertisement on the client browser from the downloaded media and player files. With this arrangement, advertising content is decoupled from web page content, since the referring web page need only include a reference to a specific ad management system, rather than having the advertisement embedded in the web page itself. Further, the advertisement rendered by the client computer can be selected based on user preference or user-specific information. However, this solution suffers from limited scalability, since such information must be uploaded to the management system prior to instantiation of the AdController applet.

Accordingly, there remains a need for an improved mechanism for delivering auxiliary content to end users over a network, which takes into account the interests and/or preferences of the recipient.

### SUMMARY OF THE INVENTION

According to a first aspect of the present invention, there is provided an auxiliary content selection system that includes a content database, and content selection means in communication with the content database. The content database includes records, each defining an item of auxiliary content and a broadcast space for delivery of the associated auxiliary content item. The broadcast space is segregated into time slots. The content selection means is configured to select one of the items in accordance with a correlation between the broadcast spaces and a time instant of a request from a client terminal for the auxiliary content.

According to a second aspect of the present invention, there is provided a method of delivering auxiliary content, that involves the steps of (1) receiving over a network a request from a client terminal for the auxiliary content, wherein each item of the auxiliary content has an associated broadcast space comprising a respective time slot; and (2) selecting one of the items in accordance with a correlation between the broadcast spaces and a time instant of a request from the client terminal for the auxiliary content.

According to a third aspect of the present invention, there is provided a computer-readable medium carrying computing instructions thereon which, when executed on a computing device, cause the computing device to (1) receive over a network a request from a client terminal for the auxiliary content, each item of the auxiliary content having an associated broadcast space comprising a respective time slot; and (2) select one of the items in accordance with a correlation between the broadcast spaces and a time instant of a request from the client terminal for the auxiliary content.

According to a fourth aspect of the present invention, there is provided an auxiliary content delivery server that includes receiving means, a content database, content selection means in communication with the receiving means and the content database, and delivery means in communication with the content selection means. The receiving means is configured to receive over a communications network a request from a client terminal for auxiliary content. The content database includes records, each defining an item of the auxiliary content and a broadcast space for delivery of the associated auxiliary content item. The broadcast space is segregated into time slots. The content selection means is configured to select the auxiliary content in accordance with a correlation between the broadcast spaces and a time instant of issuance of the request. The delivery means is configured to deliver the selected content to the client terminal over the network.

According to a fifth aspect of the present invention, there is provided a method of delivering auxiliary content, that involves the steps of (1) receiving over a network a request from a client terminal for the auxiliary content, wherein each item of the auxiliary content has an associated broadcast space comprising a respective time slot; and (2) selecting one of the items in accordance with a correlation between the broadcast spaces and a time instant of a request from the client terminal for the auxiliary content.

In a preferred implementation of the invention, the communications network is the Internet, and the client terminal comprises a computer configured with a web browser for accessing web servers over the Internet. The auxiliary content selection system is implemented in the form of computer software installed on a web server that is accessible by the client terminals over the Internet. Preferably, the web server, referred to hereinafter as an advertising distribution server, includes both the auxiliary content selection system and the content database. The present invention also includes a number of web servers that have at least one web page (“referring page”) that include a reference to the advertising distribution server.

Preferably, the auxiliary content stored in the content database comprises “rich media” advertising content, such as recycled television commercials, that is stored in the form of media files. The advertising content is targeted to different target audiences, based on the URL of the referring web page, the time instant the client terminal accesses the referring web page, and client-specific parameters such as the web browser software installed, the browser language, country, and any multimedia plug-in software installed.

The content database also includes an advertising broadcast schedule having information defining the broadcast space for each item of advertising content. The broadcast space identifies the target audience for the advertising content item, such as the URL of the referring web page, the time frame during which the advertising content item should be provided to a client terminal, and any desired associated client-specific parameters.

Preferably, advertisers who desire to broadcast their advertising content when a client terminal accesses a referring web page can search the advertising broadcast schedule and purchase an available time slot for their advertising content. Further, preferably the cost to the advertiser for rendering the advertisement varies with the time slot(s) desired, the referring web page and the country and language of the client terminal.

Each referring web page has embedded therein an HTML tag (referred to hereinafter as an advertising control tag) that includes a reference to a script file stored on the advertising distribution server. The advertising control tag may also include other commands that reference media files stored on the advertising distribution server or other computer servers. When these commands are interpreted and executed by the client browser, the referenced files are downloaded to the client terminal and their content assembled by the browser into the rendered page.

The advertising control tag then instantiates an ad viewer object, which is a group of HTML objects and tags which, when assembled together, form the object used to render the advertising content to the end-user. The ad viewer object is not a “popup”, but is instead instantiated within the referring web page(s) as an integral part of the web page itself. The HTML objects and tags comprising the ad viewer object may be provided using JavaScript or integrated within a Flash object.

After the ad viewer object is instantiated, the ad viewer object establishes a connection with the advertising distribution server, and the browser provides the advertising distribution server with the URL of the referring web page, the time instant the client terminal accessed the referring web page, and the client-specific parameters. Using some or all of this information, the advertising distribution server queries the advertising broadcast schedule for the next advertising content to be rendered on the referring web page. In response, the advertising distribution server returns the appropriate advertising content information, such as the URL address of the advertising content media file to be rendered, and a “hyperlink” to the advertiser's web site in the event of a user initiated “click-through” event on the ad viewer object.

Just as television viewers or radio listeners may tune into a particular station, at one instant during the day may have interests that are different from television viewers or radio listeners who tune into the same station at another instant during the day, users of a client terminal who access a referring web page at one instant during the day may have interests that are different from users of a client terminal who access the same referring web page at another instant during the day. Since the advertising content returned by the advertising distribution server is selected based on one or more of the URL of the referring web page, the time instant the client terminal accessed the referring web page, and the client-specific parameters, the advertising content provided to the client terminal is dynamically associated with or targeted to the current interests or preferences of the user of the client terminal. As a result, this approach allows the advertisers to tailor the subject matter of the advertising content to the different interests of their target audiences. Consequently, advertisers will be more will to pay (and the administrator of the advertising distribution server will be able to charge) a premium for “prime-time” advertising slots.

The ad viewer object is hidden from the user of the client terminal until such time that the media file has been completely downloaded to the end-user's browser cache. Upon expiry of a predefined time-out interval, the ad viewer object is rendered on the end-user's computer screen in a position visible to the end-user. The ad viewer object then “plays” the downloaded media file (the advertising content) to the user of the client terminal.

During and/or after playback of the media file, the user of the client terminal has the option to “click” on any of the navigation links (or buttons) so that he/she may visit the advertiser's web site, get more information of the product and/or service being advertised, participate in an online “ad rating” survey or send feedback or comments, etc. If on the other hand, the user elects to do nothing, after a predefined “non-event” time-out interval has expired without user intervention, the ad viewer object is automatically hidden from view and then proceeds to “setup” the next scheduled advertisement. Preferably, the lag time between successive advertisements allows for ample time to download the next media file. Otherwise, downloading of the media file will terminate so that the next successive media file can begin downloading.

Through the use of the present invention, advertisers can measure the effectiveness and efficiency of those advertising messages in terms of the total number of times the advertisement was played (either to a unique audience or the frequency of plays to the same end-user), the duration of playback (i.e. length of commercial playback before the user initiated a particular event), and measurable response rates (i.e. user-initiated “click-through” rates).

### BRIEF DESCRIPTION OF THE DRAWINGS

The present invention will now be described by way of example only, with reference to the accompanying drawings, in which:

FIG. 1 is a schematic view of the auxiliary content delivery system according to the present invention, depicting the client terminals, the referring web servers, the advertising servers and the auxiliary content delivery server;

FIG. 2 is a schematic view of the auxiliary content delivery server shown in FIG. 1;

FIG. 3 is a flowchart providing an overview of the operation of the auxiliary content delivery system;

FIG. 4 is a schematic representation of the Ad Viewer Object, as provided by the auxiliary content delivery server; and

FIG. 5 is a flowchart depicting the detailed operation of the auxiliary content delivery system.

### DETAILED DESCRIPTION OF THE PREFERRED EMBODIMENT

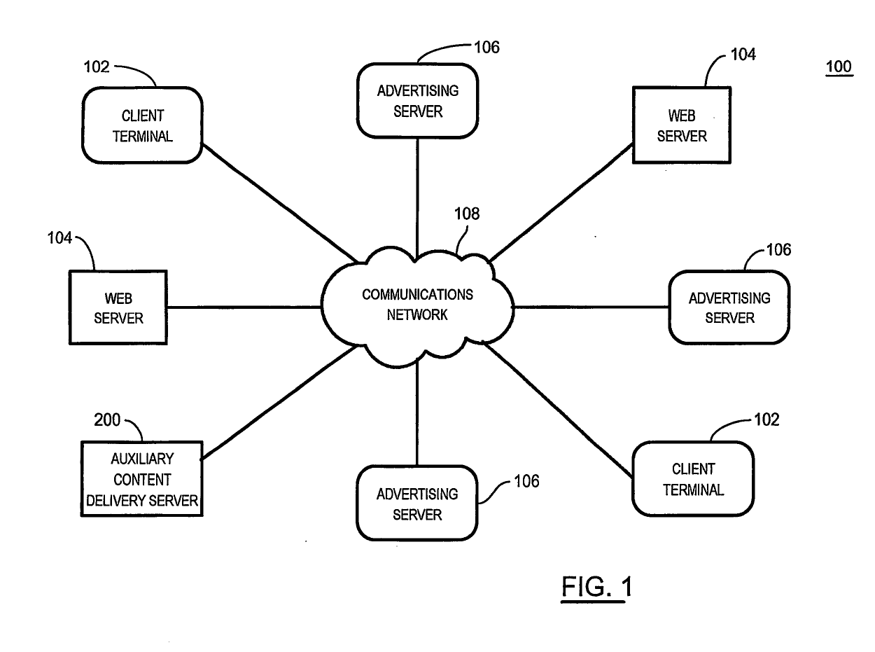

Turning to FIG. 1, there is shown an auxiliary content delivery system, denoted generally as 100, comprising a plurality of client terminals 102, a plurality of referring web servers 104, a plurality of advertising servers 106, an auxiliary content delivery server 200, and a communications network 108 interconnecting the client terminals 102, the referring web servers 104, the advertising web servers 106, and the auxiliary content delivery server 200. Preferably, the communications network 108 comprises a wide area network, such as the Internet. However, the communications network 108 could comprise other network forms, such as local area networks and wireless networks.

Each client terminal 102 comprises a personal communications device, such as a personal computer, a personal data assistant, or a web-enabled wireless telephone. The client terminal 102 comprises a memory, a data input device (such as a keyboard, writing tablet and/or mouse), a data display (such as a CRT or LCD), a network interface (such as a wired or wireless modem, or a network interface card) interfacing the client terminal 102 with the communications network 108, and a central processing unit coupled to the memory, the data input device, the data display and the network interface. The client terminal 102 is configured with computer software, stored in the memory, which when processed by the central processing unit, implements in the client terminal 102 an operating system and an Internet browser through which a user of the client terminal 102 can access web pages hosted by the referring web servers 104.

Preferably, the browser establishes a Transmission Control Protocol/Internet Protocol (TCP/IP) connection with one of the web servers 104 to pass a request for web page content. The web page is identified via a Uniform Resource Locator (URL). The specified web page can include text, graphics, and other information specified in HTML code. The browser defines a viewing area for the web page, and can be manipulated by the user located at client terminal 102. Preferably, the Internet browser comprises a HTTP-compliant web browser, such as Microsoft Internet Explorer or Netscape Navigator/Communicator.

Further, preferably the Internet browser of the client terminal 102 recognizes and interprets JavaScript and/or Jscript code. Recent browsers from Netscape and Microsoft support JavaScript, though Internet Explorer supports only a subset, which Microsoft calls Jscript. JavaScript is a lightweight scripting language that can interact with HTML source code, enabling Web authors to enhance their Web sites with dynamic content. JavaScript can also react to events and can be set to execute when something happens like when a web page has finished loading or when a user clicks on a particular HTML element. JavaScript can also read and write HTML elements, dynamically change the content of HTML elements, and validate data before it is submitted to a server.

For instance, suppose the following HTML tag element was inserted into a web page:

```
<SCRIPT Language=“JavaScript”>
  function getDate( ) {
    today = new Date( )
      document.write(“Today is ” + today)
  }
  window.onload = getDate
</SCRIPT>
```

When the web page is finished loading, the Internet browser will call the method “getdate( )”. The “getDate( )” method determines the current date and instructs the Internet browser to insert the current date into the browser document window. As a result, the following HTML tag element will be dynamically written into the web page, interpreted and rendered by the browser: “Today is Wed Apr 3 16:19:02 EST 2002”, assuming that “Wed Apr 3 16:19:02 EST 2002” was the value returned by the “new Date( )” method.

JavaScript code is advantageous, since it can be linked to a number of HTML web pages without having to embed the script code into the HTML page(s) itself. If the appropriate HTML tag element is added to an HTML page (such as <script src=“http://someplace.com/script_name.js”></script>), the HTML page will use the external JavaScript source file (identified by the “src” attribute) to dynamically add the code contained in the external source file, to the HTML page and will execute it.

Each referring web server 104 is implemented as a conventional computer server, and comprises a memory, a data input device, a data display, a network interface interfacing the web server 104 with the communications network 108, and a central processing unit coupled to the memory, the data input device, the data display and the network interface. The web server 104 is configured with computer software, stored in the memory, which when processed by the central processing unit, implements in the web server 104 an operating system, and one or more web pages.

The web pages are typically represented using Hypertext Markup Language (HTML), although other languages may be used. At least one of the web pages (a “referring web page”) has embedded therein an HTML <script> tag (referred to hereinafter as an advertising control tag or “ACT”). The ACT represents a JavaScript file that is stored on the auxiliary content delivery server 200, and which is downloaded and executed together with referring web page. The ACT also includes methods, events, functions and other HTML commands that reference other files (either stored locally, on the auxiliary content delivery server 200, or on another remote server located elsewhere on the World Wide Web). When these commands are interpreted and executed by the client browser, the referenced files are downloaded to the client terminal 102 and their content assembled by the client's browser into the rendered web page. The ACT, and the process by which the client terminal 102 accesses the advertising content, will be described in greater detail below.

Preferably, the computer software installed on the referring web server 104 also comprises Active Server Page (ASP) and/or Common Gateway Interface (CGI). ASP is Microsoft's version of CGI server-side scripting language. ASP and CGI programs both run on a web server, usually tailoring an HTML web page for an end-user. However, an ASP file is an HTML page that includes one or more scripts that are processed on a web server before the page is sent to the user. As will be explained, the script can use input received from the client terminal 102, thereby allowing the user to specify terms in which the referring web server 104 causes an application program to function. The referring web server 104 then builds or customizes the responding HTML web page on the fly before sending it to the client terminal 102. Since the server-side script simply builds a regular HTML page, the web page can be delivered to almost any browser.

Each advertising server 106 is implemented as a conventional computer server, and comprises a memory, a data input device, a data display, a network interface interfacing the advertising web server 106 with the communications network 108, and a central processing unit coupled to the memory, the data input device, the data display and the network interface. The advertising web server 106 is configured with computer software, stored in the memory, which when processed by the central processing unit, implements in the advertising web server 106 an operating system, and one or more web pages. Typically, each advertising server 106 is associated with a respective advertiser, and these latter web pages include additional information or media content associated with the goods or services marketed by the advertiser.

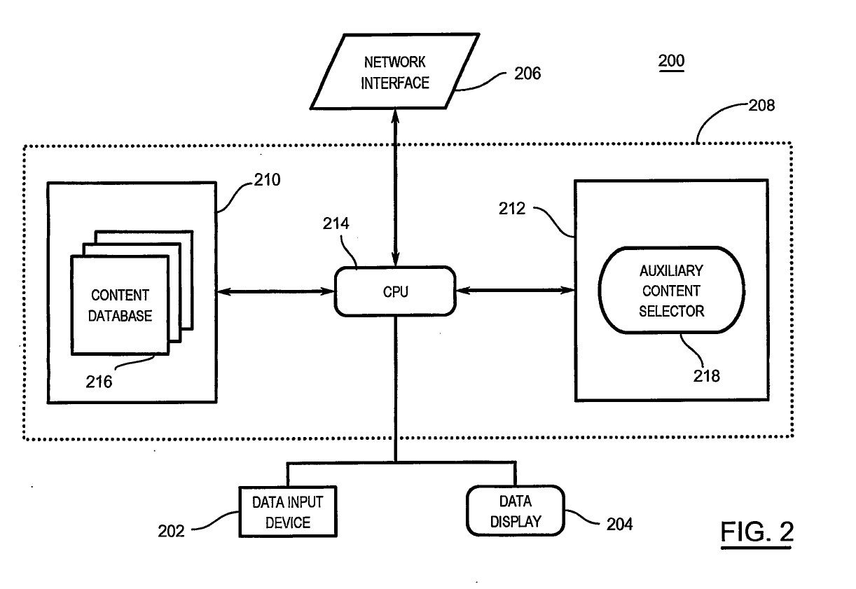

The auxiliary content delivery server 200 is implemented as a conventional computer server. As shown in FIG. 2, the auxiliary content delivery server 200 comprises a data input device 202, a data display 204, a network interface 206 interfacing the auxiliary content delivery server 200 with the communications network 108, and an auxiliary content selection system 208 coupled to the data input device 202, the data display 204 and the network interface 206. The auxiliary content selection system 208 itself comprises a non-volatile memory (ROM) 210 (such as a magnetic disc memory, an optical disc memory, or an electronic memory), a volatile memory (RAM) 212, and a central processing unit (CPU) 214 coupled to the ROM 210 and the RAM 212.

The ROM 210 includes a content database 216, and a series of computer processing instructions for the CPU 214. Typically, the content database 216 is an SQL database, and includes a number of database records, each defining an item of advertising content.

The content database 216 also includes an advertising broadcast schedule defining the broadcast delivery space for each item of the advertising content. Advertisers who wish to schedule an advertising message to be delivered to users of the client terminals 102 can purchase a desired broadcast space by providing the system administrator of the auxiliary content delivery server 200 with the information pertaining to their advertising content. Upon receipt of the requisite information, the system administrator stores the received information within the appropriate portion of the advertising broadcast schedule.

Alternately, instead of the advertising broadcast schedule being maintained on the auxiliary content delivery server 200, in one variation the web servers 104 maintain cached copies of the advertising broadcast schedule, with a master copy of the advertising broadcast schedule being maintained on the auxiliary content delivery server 200. Whenever the system administrator updates the master advertising broadcast schedule, preferably the auxiliary content delivery server 200 notifies each of the web servers 104 that an updated copy of the advertising broadcast schedule is available for download from the auxiliary content delivery server 200. Alternately, the web servers 200 may query the auxiliary content delivery server 200 periodically to determine whether their cached copy of the advertising broadcast schedule is up to date. As will become apparent, by maintaining cached copies of the advertising broadcast schedule at the web servers 104, the load on the auxiliary content delivery server 200 will be reduced, thereby increasing data throughput.

Preferably, the advertising content items are stored in the content database 216 in the form of media files (such as QuickTime movie files, Flash files, etc.). Typically, each item of the advertising content comprises an advertisement that is targeted to a different target audience, and each associated record in the content database 216 identifies the path of the associated media file(s), and the URL of a web page on the advertising server 106 that the user of the client terminal 102 can access when the advertisement is rendered on the client terminal 102.

The computer processing instructions stored in the ROM 210 together comprise computer software for the auxiliary content delivery server 200. The computer software, when loaded into the RAM 212, define an operating system, and an auxiliary content selector 218. Preferably, the auxiliary content selector 218 is implemented as an ASP file. The auxiliary content selector 218 is configured to communicate with the content database 216, and to select one of the items of the advertising content for delivery to the client terminals 102.

In one implementation, the target audience for each item of the advertising content is based on the time instant the client terminal 102 accesses one of the web servers 104. The broadcast space is segregated into time slots, and the advertising broadcast schedule defines the time instant(s) during which the associated advertising content item should be delivered to the client terminals 102. The auxiliary content selector 218 is configured to select the advertising content items in accordance with a correlation between the broadcast spaces specified in the advertising broadcast schedule, and the time instant the client terminal 102 accesses one of the web servers 104.

In another implementation, the target audience for each item of the advertising content is based on the time instant the client terminal 102 accesses one of the referring web pages, and the URL of the referring web page. The broadcast space is segregated into time slots and network addresses. The advertising broadcast schedule defines the time instant(s) during which the associated advertising content item should be delivered to the client terminals 102, and the URL of the web page that must be accessed before the associated advertising content item is delivered to a client terminal 102. The auxiliary content selector 218 is configured to select the advertising content items in accordance with a correlation between the broadcast spaces specified in the advertising broadcast schedule, and the time instant the client terminal 102 accesses the referring web page.

In another implementation, the target audience for each item of the advertising content is based on the time instant the client terminal 102 accesses one of the referring web pages, the URL of the referring web page, the language of the advertisement, and the intended jurisdiction for the advertisement. The broadcast space is segregated into time slots, network addresses, advertisement language and advertisement jurisdiction. The advertising broadcast schedule defines the time instant(s) during which the associated advertising content item should be delivered to the client terminals 102, the URL of the web page that must be accessed before the associated advertising content item is delivered to a client terminal 102, and the preferred language and country of residence for the client terminal 102. The auxiliary content selector 218 is configured to select the advertising content items in accordance with a correlation between the broadcast spaces specified in the advertising broadcast schedule, the time instant the client terminal 102 accesses the referring web page, the preferred language for the client browser of the client terminal 102, and the country in which the client terminal 102 resides.

In another implementation, the target audience for each item of the advertising content is based on the time instant the client terminal 102 accesses one of the referring web pages, the URL of the referring web page, the language of the advertisement, the intended jurisdiction for the advertisement, and client-specific parameters such as the web browser software installed, the browser language, country, and any multimedia plug-in software installed. The broadcast space is segregated into time slots, network addresses, advertisement language, advertisement jurisdiction and client type. The advertising broadcast schedule defines the time instant(s) during which the associated advertising content item should be delivered to the client terminals 102, the URL of the web page that must be accessed before the associated advertising content item is delivered to a client terminal 102, and the preferred language, country of residence and client type for the client terminal 102. The auxiliary content selector 218 is configured to select the advertising content items in accordance with a correlation between the broadcast spaces specified in the advertising broadcast schedule, the time instant the client terminal 102 accesses the referring web page, the preferred language for the client browser of the client terminal 102, the country in which the client terminal 102 resides, and the client-specific parameters.

Although the foregoing description thus far has provided four distinct definitions for a target audience, it should be understood that the present invention is not so limited. Rather, the advertising broadcast schedule can comprise any set of parameters required to reach the desired target audience. As such, the advertising broadcast schedule could define the desired target audience in accordance with any one or more of the foregoing parameters, and/or any other desired parameter(s).

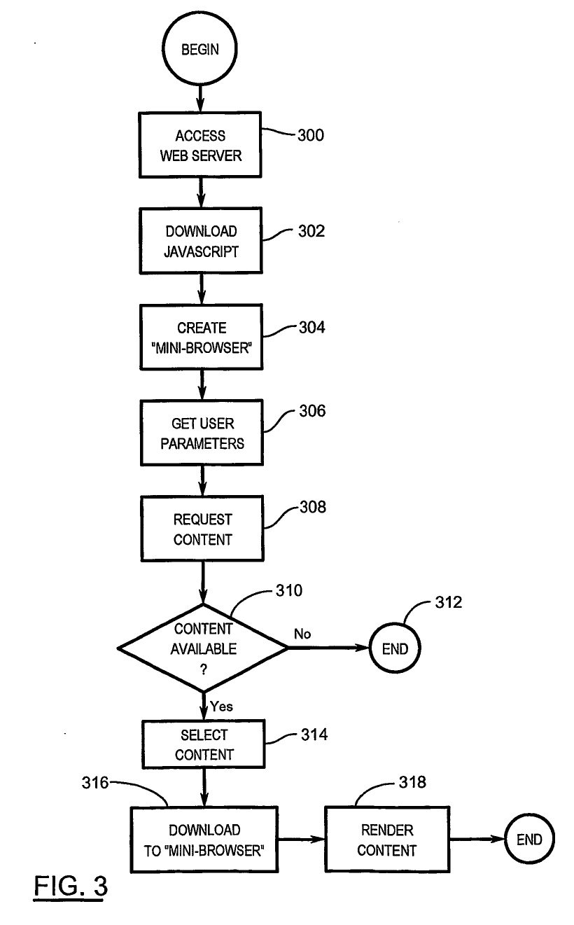

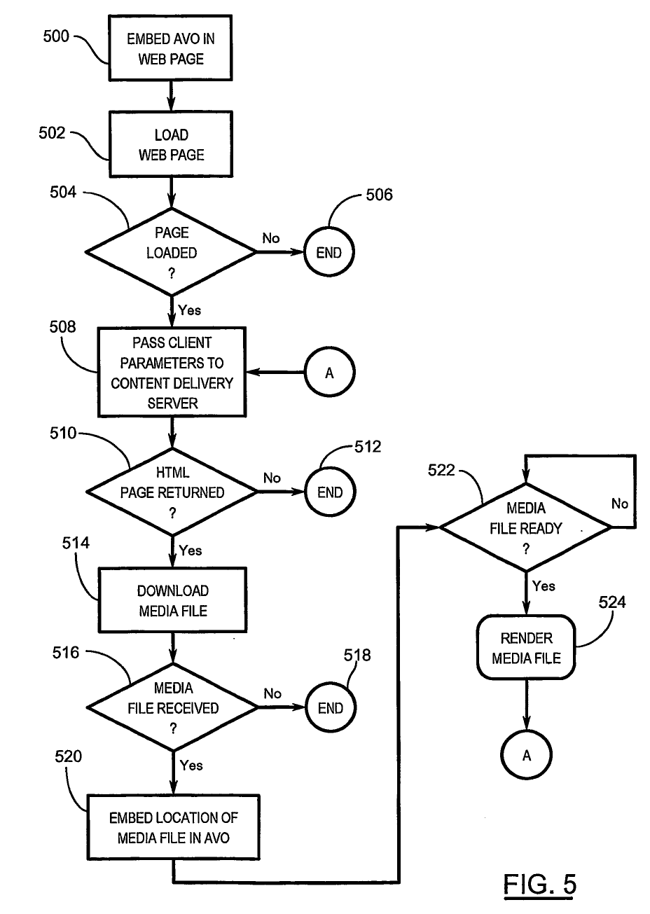

The operation of the auxiliary content delivery system 100 will now be described generally, with reference to FIG. 3, and subsequently in greater detail with reference to FIG. 5. As shown in FIG. 3, at step 300 the user of a client terminal 102 uses its Internet browser to access a referring web page hosted on a web server 104. The referring web page has embedded therein an ACT (eg. <script src=“http://www.mediaonenetwork.net/code/loadact.js></script>) that references a JavaScript file stored on the auxiliary content delivery server 200.

At step 302, the Internet browser executes the ACT, thereby requesting and downloading the JavaScript file “loadact.js” from the auxiliary content delivery server 200 (at URL http://www.mediaonenetwork.net/code). The JavaScript file “loadact.js” is hidden from view should the user then display the source code for the referring page with the Internet browser. This hinders the user, to some degree, from readily ascertaining the contents of the JavaScript file.

At step 304, the JavaScript file “loadact.js” is interpreted and executed by the Internet browser, thereby dynamically creating and embedding an Ad Viewer Object (AVO) into the referring web page. The AVO creates an inline frame, also commonly referred to as a “floating frame” or “mini-browser.

At step 306, the JavaScript file “loadact.js” instructs the client terminal 102 to conduct client-side tests for the current date and time, and client-specific data (such as the Internet browser type, language and country code [or IP address assigned to the ISP used by the network client 102]; and whether the client terminal 102 is configured with a media player, a QuickTime Player, or a Flash plug-in). At step 308, the JavaScript file “loadact.js” passes to the auxiliary content delivery server 200 the URL of the referring web server 104, the URL of the auxiliary content delivery server 200, and the client-specific parameters. This step has the effect of passing a request for advertising content from the client terminal 102 to the auxiliary content selector 218 (via the network interface 206 of the auxiliary content delivery server 200), together with any parameter values required to fulfill the content request.

The auxiliary content selector 218 receives the content request, and then attempts to select one of the items of advertising content referenced in the content database 216, based on the correlation between the broadcast spaces defined in the advertisement broadcast schedule and the parameter values received from the AVO. To do so, the auxiliary content selector 218 executes server-side script code that queries the advertisement broadcast schedule, at step 310, to determine whether the advertisement broadcast schedule includes an entry associated with the referring document URL. If the advertisement broadcast schedule does not include a corresponding entry, the process terminates, at step 312.

However, if the advertisement broadcast schedule does include a corresponding entry, at step 314 the auxiliary content selector 218 compiles a query string based on the received date and time values, the referring document URL, and the client-specific data. Using the compiled query string, the auxiliary content selector 218 retrieves from the content database 216 the path of the media file(s) associated with the selected advertisement. The media file(s) may be stored either on the auxiliary content delivery server 200 or on a “third-party” web server (not shown). The auxiliary content selector 218 may also retrieve from the content database 216 any other related information, such as the URL of the advertising server 106 associated with the selected advertisement. This URL may be linked (during rendering of the advertisement) to a user-initiated click-event so that the user, by initiating a “mouse-click” on the specific “hotlink” or “button” interface, can be transported to a related web site on the advertising server 106.

Once the appropriate data and media file address for the advertisement has been identified, at step 316 the content delivery server 200 dynamically creates an HTML page 400 that includes the selected data and media file address. The HTML page 400, when interpreted by the Internet browser of the client terminal 102, causes pre-defined HTML object elements (as required to download and render the appropriate advertisement) to be dynamically written to and embedded therein. The modified HTML page 400, when interpreted by the Internet browser, causes the selected advertisement to be rendered in the document window of the AVO, at step 318.

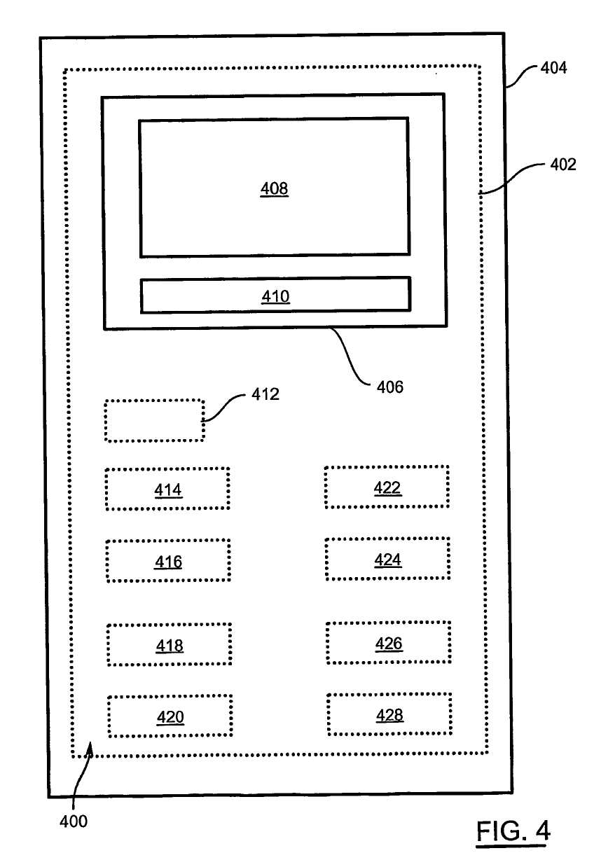

FIG. 4 illustrates the object elements included in the HTML page 400 that is created by the content delivery server 200 at step 316, as they relate to the document window (denoted by reference numeral 402) of the AVO (denoted by reference numeral 404). Reference numeral 406 symbolizes a series of HTML elements that are grouped together to create a pre-defined “Ad Viewer Skin”. The Ad Viewer Skin 406 is a collection of organized images, links and text that together, create a custom graphic interface for displaying the advertisement to the user of the client terminal 102. In addition, the Ad Viewer Skin 406 displays a series of buttons (“links”) that provide added functionality (i.e. a hyperlink link to the advertisers website, a “close” button to terminate playback of the media file, etc.).

The Ad Viewer Skin 406 also contains “Ad Object Window” 408, which is a pre-defined window area in which the media file is dynamically embedded and rendered to the user. Reference numeral 410 symbolizes a menu bar, which is the area in which user options (i.e. menu items), are displayed.

The HTML page 400 also contains a series of hidden HTML elements, one of which includes element 412, which is an <iframe> element (herein referred to as the “Ad Preloader Frame”). Reference numerals 414 to 428 symbolize <input> tag elements that are used to store data and information required to assemble, download and display the advertisement to the end-user in the Ad Object Window 408, and additionally to store user “click-events” which are triggered by a user response to the advertisement.

For instance, if the AVO 404 includes a “Replay” or a “Save” button, and the user clicks on the button to thereby replay or save the advertisement on the hard-drive of the client terminal 102, the click-event causes the AVO 404 to replay or save the advertisement, as appropriate, and to transmit the click-event back to the content delivery server 200. The click-events are then logged to the content database 216, to thereby allow the system administrator to generate a report for each advertiser which identifies the number of times the advertisement was viewed, the number of users who accessed the advertisement, the time slots during which the advertisement was accessed, and the referring web site for the advertisement. Alternately, this information can be accessed by the advertiser over the Internet, via an account created for each advertiser. Further, the system administrator can review the information in the content database 216 identifying the number of hits for each referring web site at each time slot, to thereby alter the cost charged to each advertiser based on the popularity of the web site and the time slot.

Thus far in the discussion, JavaScript has been the only mechanism disclosed for implementing the AVO 404. However, the present invention is not so limited. Rather, in one variation, the objects of the AVO 404 are contained in a Flash object, which can be executed using Macromedia's Flash Player technology. Flash Player technology is a desirable platform upon which to deliver advertising content since it allows advertisements to be deployed consistently across a broad array of platforms. Further, the platform can support motion graphics, video, audio, two-way communications, and complex animation forms, thereby providing the opportunity of a significantly more robust environment for the creation of media rich advertisements. Additionally, the resulting compiled client-side applications can be delivered easily as files via HTTP.

Additional details concerning the rendering of the advertisement at the AVO 404 will now be discussed with reference to FIG. 5. As shown, when the JavaScript file “loadact.js” is first executed by the Internet browser (step 304), the JavaScript file calls “initAdViewer” event at step 500, which instructs the Internet browser of the client terminal 102 to dynamically create and embed the AVO 404 into the referring web page. The AVO 404 is an HTML <iframe> tag element that creates an inline frame, and can act as a “target” for other URL links. The <iframe>'s SRC attribute provides the location of the frame content. The AVO 404 is rendered as a “hidden” object and therefore is not visible to the user of the client terminal 102. The AVO 404 can function in a wide variety of computing environments, without changes to the coding of JavaScript file 901 itself. This is accomplished through the request and downloading of an external HTML document (an agent file) from the content delivery server 200. Changing parameter values in the agent files permits the display and/or behavior of the AVO 404 to be changed without a need to utilize a different version of the JavaScript file for each different environment.

At step 502, the JavaScript file calls “on Load” event, which cases execution of the JavaScript file to pause until the referring web page has been completely downloaded and rendered to the user of the client terminal 102. Once the referring web page has been rendered and displayed, at step 504 the JavaScript file determines whether the AVO 404 properly instantiated within the “document body” of the referring web page. If the AVO 404 failed to instantiate, the JavaScript file terminates at step 506. Otherwise, the JavaScript file calls “buildRequest” event, at step 508.

The “buildRequest” event causes the AVO 404 to request from the content delivery server 200 a URL to the appropriate media file(s) for the next advertisement. To initiate the request, the JavaScript file dynamically assembles a URL comprising the merger of the URL to the content delivery server 200, the URL of the referring web server 104, the current date and time, and the client-specific data (step 306). The JavaScript file then writes the assembled URL (eg. http://www.ads.com/adquery.asp?datetime=Wed Apr 3 16:19:02 EST 2002&docURL=http://www.some_domain.com/some_page.htm) to the SRC attribute of the <iframe> tag element. This step has the effect of passing a request for advertising content from the client terminal 102 to the auxiliary content selector 218. The AVO 404 is the target window for server responses resulting from this request.

A sample <iframe> tag element, resulting from step 508 is shown below:

```
<iframe id = ‘adViewer’
  style = ‘position:absolute;
      visibility:visible;
      width:0px; height::0px;’
  frameborder = ‘0’
  scrolling = ‘no’
  allowtransparency = ‘true’
  src = http://www.ads.com/adquery.asp?datetime= Wed
    Apr 3 16:19:02 EST 2002&docURL=http://www.some_domain.com/
    some_page.htm>
</iframe>
```

The assembled URL (identified by the SRC attribute) is a request to the auxiliary content selector 218 on the content delivery server 200. The auxiliary content selector 218 uses the parameter values (passed to the auxiliary content selector 218 as part of the SRC attribute) to select the appropriate auxiliary content for the client terminal 102.

The JavaScript file then pauses, at step 510, until the auxiliary content selector 218 responds with an HTML page 500 (created “on the fly” via steps 310 to 316) that includes the URL to the appropriate media file(s) for the next advertisement, and is successfully downloaded to the “document window” of the AVO 404. If the auxiliary content selector 218 fails to return an HTML page 500, the JavaScript file terminates, at step 512.

On the other hand, if the auxiliary content selector 218 does return an HTML page 500, at step 514 the JavaScript file calls “preLoadAd” event that initiates the Ad Preloader Frame 412. The Ad Preloader Frame 412 is a hidden HTML <iframe> element that requests download of the media file specified by its SRC attribute. The “preLoadAd” event dynamically assembles an HTTP request for the media file associated with the next advertisement and then dynamically formats the SRC attribute of the Ad Preloader Frame 412 with the URL of the requested media file.

The JavaScript file then pauses, at step 516, until the media file has been completely downloaded to the Ad Preloader Frame 412 which, in turn, causes the media file to be stored in the cache associated with the user's Internet browser. If the Ad Preloader Frame 412 fails to receive the requested media file, the JavaScript file terminates, at step 518.

On the other hand, if the requested media file has been completely downloaded (and stored in the browser cache), the JavaScript file calls event “loadAd2ViewerScreen( )”, at step 520, which dynamically assembles an HTML “<object>” element and embeds the location of the downloaded media file in the object's SRC value. The downloaded media file is then immediately loaded to the <object> element, ready for playback to the user of the client terminal 102.

At step 522, the JavaScript file determines whether the media file is loaded and ready for playback. If so, the JavaScript file causes the AVO 404 to render (display) the commercial to the user, at step 524. Once the AVO 404 becomes visible in the Internet browser, the JavaScript file instructs the AVO 404 to commence the broadcast session by playing back the media file.

After the broadcast session is completed (either by the expiry of a predetermined “inactive” time-out event or a user-initiated “click” event), the JavaScript file calls the “buildrequest( )” event, at step 508, to thereby initiate downloading and playback of the next advertisement. Since the “time” of the request will then be different (eg. 5 minutes later), the query of the advertising broadcast schedule (at step 310) will result in a different media file being returned and rendered.

The present invention is defined the claims appended hereto, with the foregoing description being illustrative of a preferred embodiment of the invention. Those of ordinary skill may envisage certain modifications to the described embodiment which, although not explicitly disclosed herein, do not depart from the scope of the invention, as defined by the appended claims.

1. An auxiliary content selection system comprising:
a content database of records each defining an item of auxiliary content, and a broadcast space for delivery of the associated auxiliary content item, the broadcast space being segregated into time slots; and
content selection means in communication with the content database for selecting one of the items in accordance with a correlation between the broadcast spaces and a time instant of a request from a client terminal for the auxiliary content.

2. The auxiliary content selection system according to claim 1, wherein the client terminal is configured to communicate with at least one network resource accessible over a network, the broadcast space is segregated into the time slots and network addresses, and the content selection means is configured to select the auxiliary content in accordance with a correlation between the broadcast space, and the time instant and a network address of the at least one network resource.

3. The auxiliary content selection system according to claim 1, wherein the client terminal has a configuration including at least one of a preferred language and a client jurisdiction, the broadcast space is further segregated into advertisement language and advertisement jurisdiction, and the content selection means is configured to select the auxiliary content in accordance with a correlation between the broadcast space and the client configuration.

4. A computer-based method of delivering auxiliary content comprising the steps of:
receiving over a network a request from a client terminal for the auxiliary content, each item of the auxiliary content having an associated broadcast space comprising a respective time slot; and
selecting one of the items in accordance with a correlation between the broadcast spaces and a time instant of a request from the client terminal for the auxiliary content.

5. The method according to claim 4, wherein the client terminal is configured to communicate with at least one network resource accessible over the network, the broadcast space is segregated into the time slots and network addresses, and the content selection step comprises selecting the auxiliary content in accordance with a correlation between the broadcast space, and the time instant and a network address of the at least one network resource.

6. The method according to claim 4, wherein the client terminal has a configuration including at least one of a preferred language and a client jurisdiction, the broadcast space is further segregated into advertisement language and advertisement jurisdiction, and the selection step comprises selecting the auxiliary content in accordance with a correlation between the broadcast space and the client configuration.

7. The method according to claim 4, further comprising the steps of maintaining an advertising broadcast schedule defining the broadcast spaces, and transmitting copies of the advertising broadcast schedule to web servers over the network.

8. A computer-readable medium carrying computing instructions thereon which, when executed on a computing device, causes the computing device to:
receive over a network a request from a client terminal for the auxiliary content, each item of the auxiliary content having an associated broadcast space comprising a respective time slot; and
select one of the items in accordance with a correlation between the broadcast spaces and a time instant of a request from the client terminal for the auxiliary content.

9. The computer-readable medium according to claim 8, wherein the client terminal is configured to communicate with at least one network resource accessible over the network, the broadcast space is segregated into the time slots and network addresses, and the content selection step comprises selecting the auxiliary content in accordance with a correlation between the broadcast space, and the time instant and a network address of the at least one network resource.

10. The computer-readable medium according to claim 8, wherein the client terminal has a configuration including at least one of a preferred language and a client jurisdiction, the broadcast space is further segregated into advertisement language and advertisement jurisdiction, and the selection step comprises selecting the auxiliary content in accordance with a correlation between the broadcast space and the client configuration.

11. The computer-readable medium according to claim 8, further comprising the steps of maintaining an advertising broadcast schedule defining the broadcast spaces, and transmitting copies of the advertising broadcast schedule to web servers over the network.

12. An auxiliary content delivery server comprising:
receiving means for receiving over a communications network a request from a client terminal for auxiliary content;
a content database of records each defining an item of the auxiliary content, and a broadcast space for delivery of the associated auxiliary content item, the broadcast space being segregated into time slots;
content selection means in communication with the receiving means and the content database for selecting the auxiliary content in accordance with a correlation between the broadcast spaces and a time instant of issuance of the request; and
delivery means in communication with the content selection means for initiating delivery of the selected content to the client terminal over the network.

13. The auxiliary content delivery server according to claim 12, wherein the client terminal is configured to communicate with at least one network resource accessible over the network, the broadcast space is segregated into the time slots and network addresses, and the content selection means is configured to select the auxiliary content in accordance with a correlation between the broadcast space, and the time instant and a network address of the at least one network resource.

14. The auxiliary content delivery server according to claim 12, wherein the client terminal has a configuration including at least one of a preferred language and a client jurisdiction, the broadcast space is further segregated into advertisement language and advertisement jurisdiction, and the content selection means is configured to select the auxiliary content in accordance with a correlation between the broadcast space and the client configuration.

15. The auxiliary content delivery server according to claim 12, further configured to maintain statistics of the content delivery.

16. The auxiliary content delivery server according to claim 12, further configured to maintain an advertising broadcast schedule defining the broadcast spaces, and transmit copies of the advertising broadcast schedule to web servers over the network.

17. A computer-based method of delivering auxiliary content comprising the steps of:
defining a plurality of broadcast spaces, each said broadcast space comprising a respective time slot for delivery of the auxiliary content over a communications network, and a fee payable for the delivery during the associated time slot;
receiving over a network a request from a client terminal for the auxiliary content, each item of the auxiliary content having an associated broadcast space comprising a respective time slot; and
selecting one of the items in accordance with a correlation between the broadcast spaces and a time instant of a request from the client terminal for the auxiliary content.
